(19) United States
(12) Patent Application Publication
(10) Pub. No.: US 2010/0224017 A1
(43) Pub. Date: Sep. 9, 2010

(54) Linear Actuator Device

(75) Inventor: Jens Jørgen Nielsen, Broager (DK)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: Linak A/S

(21) Appl. No.: 12/223,979

(22) PCT Filed: Feb. 16, 2007
(86) PCT No.: PCT/DK2007/000076

§ 371 Date: Aug. 14, 2008

(30) Foreign Application Priority Data
Feb. 18, 2006 (DK) PA 2006 00234

(51) Int. Cl. F16H 25/20

(52) U.S. Cl. 74/89.23

(57) ABSTRACT

A linear actuator device for pieces of furniture, e.g. beds, is described which include an adjustable section (2, 3) pivotally embedded in a frame (1). The section (2, 3) is raised and lowered by at least one rod (23, 24) mounted on a pivot shaft (4, 6). The actuator comprises a housing (8) with a bushing (10) receiving the pivot shaft (4, 6), and a spindle (14) driven by a low-voltage DC motor (11). The spindle (14) carries a spindle nut (12) fixed against rotation which in one direction of motion operates an arm (5, 7) mounted on the pivot shaft (4, 6) for adjusting the section within the piece of furniture. By designing the arm (5, 7) such that, when it engages the spindle nut (12), it will rest against an area (17) of the nut's end which faces farthest away from the shaft, an expedient moment curve for pivoting the section is obtained, as a large moment occurs at the beginning and the end of the section's movement just when needed. In the initial horizontal position of the section, a large moment is needed, and so is in the end position, when for instance a mattress is folded which requires a large moment. The area, which the end of the arm (5, 7) rests against is expediently equipped with a roller (17) which reduces friction and wear on the spindle nut.

The present invention relates to a linear actuator device as stated in the preamble of claim 1.

This kind of linear actuator devices is used for beds and chairs with at least one adjustable section pivotally embedded in a frame. The section is raised and lowered by means of one or two rods mounted on a pivot axis. On said pivot axis an arm is in engagement with a spindle nut forming part of the actuator. The actuators are in the form of one embodiment in which a separate drive unit in a joint housing is placed at each end, or of another embodiment having only one drive unit. The first one of these embodiments is e.g. known from EP 0 372 032 to Dewert and the second one from WO 2005/112709 A1 to Dewert.

Typically, the spindle nut is designed and shaped from plastic material as a quardrangular sliding element, with an arm on the pivot axis resting against one end face thereof. Normally, the arm is made from metal, and the spindle nut is highly exposed to wear at the position at which the arm rests against said spindle nut. The spindle nut will be made from plastic material following the requirements for low noise level as well as for minimum friction and also the demand for low manufacturing costs.

Also, there is the issue of the forces involved. As the arm pivots about a point thus describing a circular arc while, at the same time, the spindle nut performs a linear movement this causes the place of engagement of the arm at the end of the spindle nut to move. During the introductory movement, when the section is raised the lever arm is short as the arm then lies high on the end of the spindle nut. During further movement the length of the moment arm increases and decreases at the end, when the section approaches its fully upright position. This resembles a moment curve, which rises from a certain level and then decreases again. Such a course of the moment curve is not particular expedient. The section also describes an arc of a circle, wherein the moment curve is largest when the section is in a horizontal position and the lever or moment arm decreases in correspondence with the raising of the section. Thus, at the beginning a large moment is needed, which does not match with the moment curve of the actuator. Towards the fully upright position a large moment is needed as well, which for a bed is due to the fact that the mattress which often is rather thick must be bent by a certain angle. This requires a moment of a considerable size. Ideally, the position of engagement of the arm would permanently lie exactly in the longitudinal axis of the spindle to avoid biasing of the spindle. For the largest possible torque applied on the respective section, the arm should be as long as possible. However, this is inconsistent with the requirement for minimum height of installation of the actuator. In contrast to a fairly long arm at the end of the spindle nut, which, for example is known from EP 0 372 032 B1 to Dewert and DE 38 42 078 C2 to Okin, constructions have recently been suggested having a short arm with two legs riding astride the spindle and engaging both sides of the end face of the spindle nut, as, for example, is shown in WO 2005/110158 A1 to Okin. The problem concerning the length of the moment arm is, for instance, discussed in DE 296 07 493 U1 to Dewert. Said document suggests a specific embodiment for both the arm and the spindle nut. The arm is constructed as an inverted V, with one leg being designed for engaging the front part of the spindle nut. The other leg extends into an opening in the front part of the spindle nut and is intended for engaging a surface in the opening facing forward. During the pivoting movement one of the legs rests against the front surface of the spindle nut and is released at a given angle and the other leg engages the surface in the opening. This, to a certain degree, helps to balance the length of the moment arm.

The object of the invention is to achieve an enhanced course of the moment curve for the arm.

According to the invention this is achieved by means of an embodiment of the actuator device set forth in claim 1, in that the arm is designed such that, when it engages the spindle nut, it will rest against an area towards the side of the spindle nut situated farthest away from the pivot shaft, so that the longest possible moment arm for the given construction is obtained. Herein, the moment curve has a course which starts with a fairly high moment, then decreases and then rises again, that is, the largest moment is during both the introductory movement of the section and during the closing movement, during which positions or periods of movement the largest moment is needed. This permanently causes a biasing force on the spindle, which, however, is not larger than in the known constructions.

Expediently, the spindle nut is constructed with a roller or a wheel for engaging the arm. This, primarily, results in low friction, so that thereby higher efficiency may be obtained. At the same time wear on the ends of the spindle nut is reduced. The roller can thus be made from a material having increased hard-wearing properties when compared with the remainder of the nut; moreover the roller may be designed to bring about self-lubricating qualities. For the sake of completeness it is noted that a construction is known from DE 197 52 234 A1 to Hanning wherein the arm itself on the pivoting shaft is equipped with a ball bearing, which is a more difficult and exposed construction.

Embodiments of the present invention will now be explained in greater detail with reference to the accompanying drawings, in which:

FIG. 1 shows a (slatted) frame for a bed with raised upper body and leg sections;

FIG. 2 shows a perspective view of a dual actuator;

FIG. 3 shows a longitudinal sectional view of the left end of the actuator shown in FIG. 2 for actuating the head section of the frame;

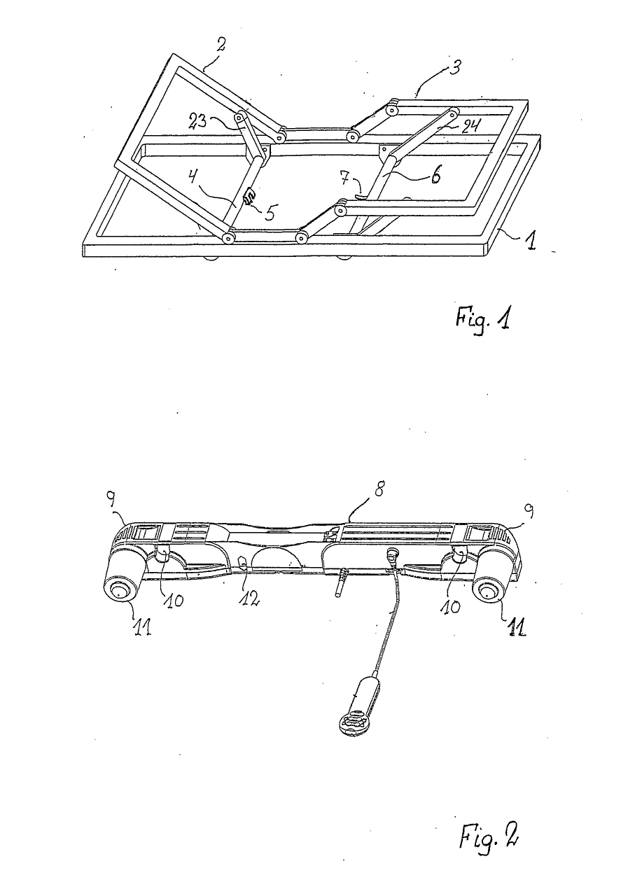

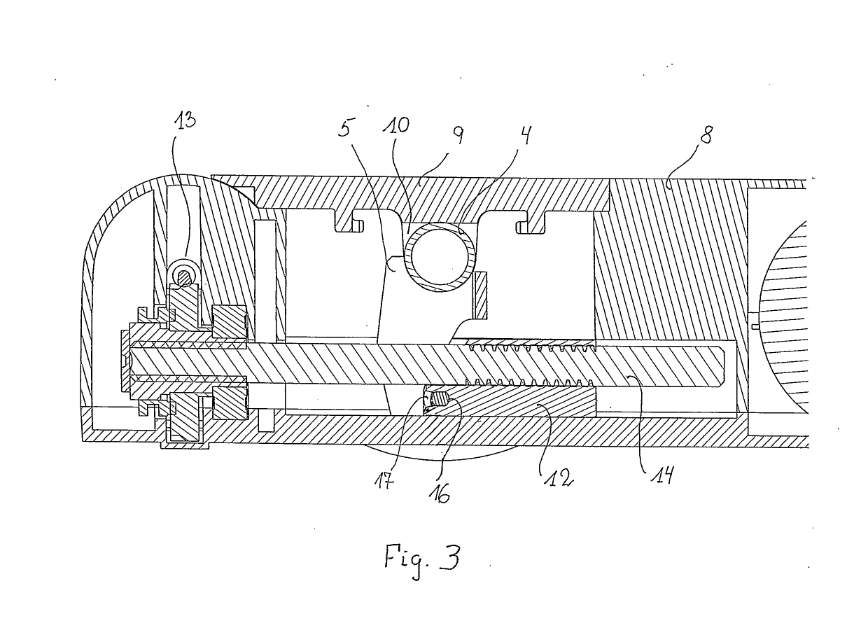

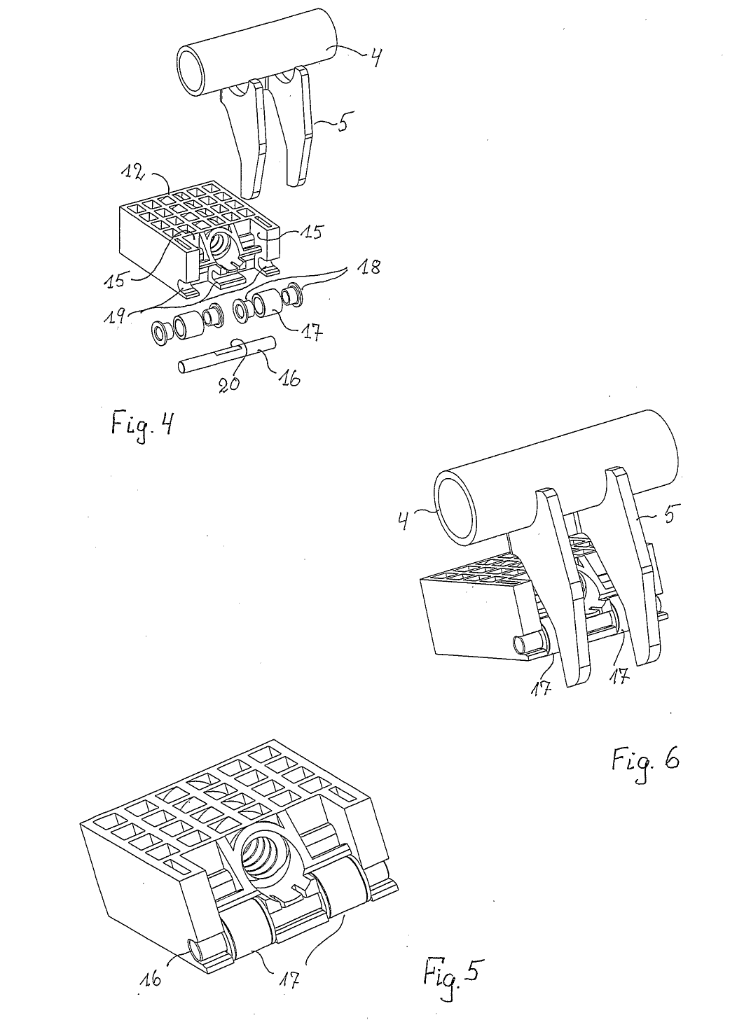

FIG. 4 shows an exploded perspective view of a spindle nut and claw;

FIG. 5 shows a perspective view of the spindle nut seen from the front;

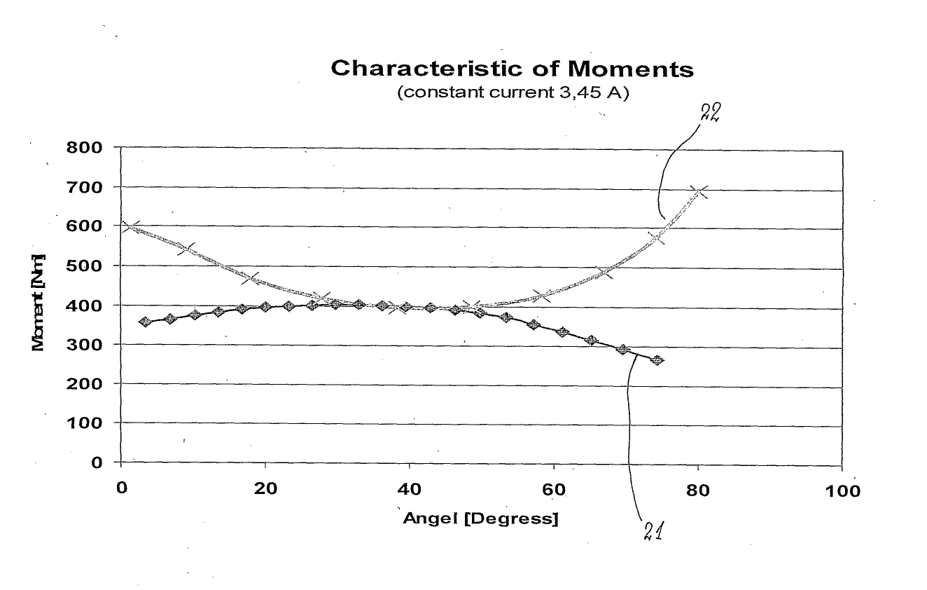

FIG. 6 shows a perspective view of the spindle nut and claw seen from the front; and

FIG. 7 shows a diagram of two moment curves, one characteristic of the actuator according to the invention and one of a known construction, respectively.

As it appears from FIG. 1 a slatted bed as e.g. to be used in a hospital bed comprises a basic frame 1, in which there is emdedded an upper body section 2 and an articulated leg section 3. A transverse shaft 4 carrying a short arm 5 is embedded in the frame for operating the upper body section 2. One rod 23 each connected to the upper body section 2 is mounted on each end of pivot shaft 4. In a similar manner, and regarding leg section 3, there is a pivot shaft 6 carrying a short arm 7 for operating leg section 3. Also, there is one rod 24 each mounted on the ends of shaft 6 and connected to leg section 3.

The movement of the upper body- and leg-sections 2,3 is achieved by means of a dual actuator device as shown in FIG. 2. This actuator device comprises a housing 8, having a sliding cover 9 at the ends, said cover enabling access to a transverse shaft opening 10 forming a bushing. A drive is provided in functional connection with the shaft openings and is driven by a low-voltage DC motor 11, mounted essentially perpendicular to the main housing 8. Motor 11 drives a spindle 14 via a worm gear 13. Said spindle carries a spindle nut 12 designed as a sliding element. This is fixed against rotation within the housing B. By rotation of spindle 14 the sliding element 12 is moved back and forth, respectively, depending on rotary direction of the spindle. As the arm 5 on swiveling or pivot shaft 4 of upper body section 2 engages the end of sliding element 12, the upper body section will be turned up and down, respectively, following rotation of spindle 14. The drive at the other end of the dual actuator operates the leg section 3 in a similar manner as described before in context with upper body section 2.

The dual actuator device is mounted on the slatted bed by pulling the sliding covers 9 outwards and guiding the actuator inwards until the pivot shafts 4,6 are fully seated in the bushing-forming openings 10 and the respective portions of arms 5,7. The covers 9 are closed again by sliding inwardly, whereby the actuator is suspended from the pivot shafts 4,6. When the drives are activated, the pivot shafts will be swiveled, which causes the upper body and the leg sections, respectively, to be raised or lowered, depending on the direction of rotation of the drive as explained above.

FIGS. 3 to 6 of the drawings will be described in the following with reference to the upper body section 2, only. The arm 5 on swiveling or pivot shaft 4 is a claw shaped element having two legs by which it straddles the spindle 14. In the front part of the spindle nut 12, which can be made from plastic material, there are two notches 15, at the bottoms of which there is arranged a roller 17 mounted on two bushings 18 which are seated on a mutual axle 16. This axle 16 together with the rollers 17 mounted thereon is held in a snap lock fit in grooves 19 designed for such purpose. Axle 16 is fixed against lateral displacement with the aid of a cut-out or recess portion 20, which fits in a middle portion of groove 19 holding axle 16. To this end, a snap lock fit is sufficient as the rollers 17 are never charged by traction forces, but are solely pressure loaded or released. The claw shaped arm 5 engages the rollers 17 by its lower ends.

It should be noted that the opposite end of the actuator, which operates the leg section 3 and the arm 7 on the pivot shaft 6 is designed in a similar manner as to what has been described in the foregoing.

In FIG. 7 of the drawings there are shown two moment curves, of which a curve 21 represents the moment curve of a hitherto known actuator in which the arm rides astride the spindle and engages the end face of the sliding element on both sides of the spindle. The second curve 22 reflects the moment curve for an actuator according to the invention. In the prior art construction the moment is very low at the beginning of movement and at its end, whereas the curve representing the construction according to the invention shows the highest values of the moment at the beginning of the movement and at its end, just when the highest moment possible is needed.

1. Linear actuator device designed for use in pieces of furniture which include at least one adjustable section (2,3) which is embedded in a frame (1) in pivoting manner and wherein said at least one section is raised or lowered by at least one rod (23,24) mounted on a shaft (4,6), wherein the actuator device comprises a housing (8) including bushing means (10) for receiving the pivot shaft (4,6), and wherein the actuator device comprises a spindle (14) driven by an electric motor (11), the spindle (14) carrying a spindle nut (12) fixed against rotation, which nut with one end face in one direction of movement of the spindle nut operates an arm (5,7) on the pivot shaft (4,6) for adjusting said at least one section (2,3) within the piece of furniture, wherein the arm (5,7) is constructed so that when it engages the end face of the spindle nut (12), it rests against an area (17) of the end face which is situated farthest away from the pivot shaft (4,6).

2. Actuator device as claimed in claim 1, wherein at least one roller (17) arranged and designed for engaging the arm (5,7) is embedded in the spindle nut (12).

3. Actuator device as claimed in claim 2, wherein the arm (5,7) is designed in the shape of a claw defining two legs, and one roller (17) each is provided for each of the two legs.

4. Actuator device as claimed in claim 3, wherein the roller(s) (17) is arranged in a notch (15) in the end face of the spindle nut (12).

5. Actuator device as claimed in claim 4, wherein the roller(s) (17) is seated on an axle (16).

6. Actuator device as claimed in claim 5, wherein the axle (16) is held in a snap lock fit in at least one groove (19) at the end face of the spindle nut (12).

7. Actuator device as claimed in claim 5, wherein the axle (16) is fixed against lateral displacement with the aid of a cut-out or recess portion (20), which fits in a groove (19).
